(19) United States
(12) Patent Application Publication
(10) Pub. No.: US 2002/0186113 A1
(43) Pub. Date: Dec. 12, 2002

(54) Induction winding

(76) Inventors: Olof Hjortstam, Vasteras (SE); Peter Isberg, Vasteras (SE); Svante Soderholm, Vasteras (SE)

Correspondence Address: Edward A Pennington, Swidler Berlin Shereff Friedman, Suite 300, 3000 K Street NW, Washington, DC, 20007-5166, US

(21) Appl. No.: 10/048,960

(22) PCT Filed: Mar. 30, 2001
(86) PCT No.: PCT/SE01/00697

(30) Foreign Application Priority Data
Mar. 30, 2000 (SE) 0001123-9
May 12, 2000 (SE) 0001748-3

(51) Int. Cl. H01F 27/08

(52) U.S. Cl. 336/55

(57) ABSTRACT

An induction winding containing at least one turn of current-carrying means that include at least one electric conductor comprising nanostructures

### TECHNICAL FIELD

The present invention relates to an induction winding and a method for its production. The term induction winding includes all induction windings comprising at least one turn of an electric conductor. More particularly the present invention relates to a compact induction winding capable of conducting large currents with low conduction losses.

### BACKGROUND OF THE INVENTION

When a current flows through a conductor, a magnetic field is generated around the conductor. If the conductor is formed into a coil whose length is much greater than it's radius, the magnetic flux density, B, is given by:

$$B = \frac{{μ}_{i} {μ}_{0} I N}{l}$$

where μᵣ is the relative permeability, μ₀ is the permeability of free space, l is the current flowing through the conductor and N is the number of turns constituting the coil. The relative permeability is dimensionless and it's value depends on the material inside the coil (for air μᵣ≈1 whereas the presence of a magnetic core can raise the value of μᵣ up to 1×10⁶).

A particle with charge Q moving with a velocity v in a magnetic field, B, experiences a magnetic force F_{B} equal to:

\overline{F}_{B}=Q=\overline{v}×\overline{B}

The magnetic force F_{B} is perpendicular to both v and B. A consequence of the above equation is that a conductor of length l in which a current i is flowing, experiences a force equal to F_{B}=B.i.l in a magnetic field B if the vectors B and l are perpendicular to each other. This is the theoretical foundation for all rotating electric machines. The force on a current-carrying coil produces a torque that causes a rotor to rotate when the coil passes through a magnetic field. A rotating electric machine's effective output is determined by the magnetic flux density in its stator and rotor, the maximum electric field strength in it's insulating material and the current density in it's coil.

The magnetic flux varies if the current through a conductor varies. Conversely, a variable magnetic field causes a current to flow in a conductor subjected to such a field. The phenomenon is called induction. Each change in the current leads to an induced voltage in the coil. The induced voltage, e, in a coil having N turns whose length is much greater than it's radius is given by:

$$e = - L \frac{ⅆ i}{ⅆ t} ; L = {μ}_{0} {μ}_{r} A \frac{{N}^{2}}{l}$$

where the minus sign in the first equation indicates that the direction of the induced voltage opposes the change which has produced it, i is alternating current and A is the cross-sectional area of the coil. A coil's inductance, L, depends on it's geometry, the number of turns it has and the material in it's core.

Induced voltages cause a conductor's electrons to move in circular paths. These so-called eddy currents give rise to their own magnetic field that opposes the variable magnetic field creating them. Eddy currents therefore give rise to the dissipation of energy that is taken from the variable magnetic field.

Eddy currents losses in a conductor are small compared with losses due to a conductor's resistance. The more turns in a coil, the longer the conductor and therefore the greater the resistance. When a current flow through the conductor, energy is dissipated in the form of heat. These losses are called copper losses and their magnitude can be calculated using the formula l²R where l is the current through the conductor. The resistance, R of a homogeneous conductor of length/and having a cross-sectional area A, is given by;

$$R = \frac{ρ l}{A}$$

where ρ is the conductors resistivity. From the equation above it can be seen that the resistance of a conductor, and consequently copper losses, can be decreased by using a conductor having a large cross-sectional area however this is disadvantageous because this increases the coil's size and weight.

Apart from eddy current losses and copper losses in the conductor, further losses arise in coils having a core comprising electrically conducting material due to eddy currents in the core and hysteresis losses. All of these losses, which result in the dissipation of heat, decrease the efficiency of devices which contain induction coils. In most cases it is necessary to cool down such devices to prevent the generated heat from damaging the devices' components.

Induction coils are used in many different types of device in conjunction with energy generation, transformation, transmission and consumption. A transformer is used in the transmission and distribution of electric energy, it's function being to exchange electric energy between two or more systems. A reactor is a essential component in power grids for example in reactive power compensation and filtering. An electromagnet is used in many applications. It creates a magnetic field when a current flows through it's induction winding. Electromagnetic induction is also utilized in a compensator, a frequency converter, a static converter, a resonator any many other devices. In summary induction windings are used in static electric machines, such as those mentioned above, as well as in rotary electric machines such as motors and generators.

Conventional induction windings are insulated. It is important to minimise the risk of cavities and pores arising in the insulation for high voltage applications as these can lead to partial discharges in the insulation material at high field strengths. Cavities and pores can arise during the production of an induction winding or under its use due to mechanical or thermal loads especially at the interface between the electric conductor and the insulation material. Ozone, which damages organic compounds, can be produced as a result of partial discharges.

WO 9745847 describes a rotating machine comprising a high-voltage induction winding which can be connected directly to a high-voltage power grid. WO 9839250 describes a new type of conductor that contains carbon nanotubes in the form of continuous fibres consisting of metallic single-wall carbon nanotubes. Fullerenes, of which carbon nanotubes are an example, were discovered in 1985. (See “C₆₀: Buckminsterfullerene”, Kroto H. W, Heath J. R, O'Brien S. C, Curl R. F och Smalley R. E, Nature vol. 318, p162, 1985). Carbon nanotubes are hollow tube-like molecules. Single-wall carbon nanotubes can have either metallic or semiconducting properties. Carbon nanotubes can exist as single- or multi-wall, open or closed tubes, normally 1,2-1,5 nm in diameter and at least 5 μm in length.

When they condense, single-wall carbon nanotubes have a tendency to form groups containing 10 to 1000 parallel single-wall carbon nanotubes. These so-called ropes, have a diameter of 5-20 nm. Carbon nanotube ropes exhibit two-dimensional triangular geometry and it is believed that the carbon nanotubes are held together by Van der Waals forces.

Carbon nanotubes are so-called one-dimensional ballistic conductors. This means that electrons are transported only in the direction along the carbon nanotube's length and conduction losses in this direction are negligible. Scattering of the electrons only occurs at the ends of the carbon nanotube. This scattering gives rise to conduction losses and therefore a nanotube's resistance is independent of the nanotube's length. This has been indicated in a lot of experimental work. Furthermore carbon nanotubes have extremely good mechanical properties such as high fracture resistance and high flexibility. They have a low density and high hot-and-cold resistance.

Large current densities (exceeding 1×10⁶ A/cm²) can potentially be transferred through individual carbon nanotubes and conductors containing carbon nanotubes can therefore be made to be extremely compact. Wang and de Heer, in the “Symposium on Energy Landscapes in Physics, (session WC35.02) March 1999, reported that electrons are conducted through carbon nanotubes, up to 5 μm long, without generating heat at room temperature.

### SUMMARY OF THE INVENTION

One aim of the present invention is to produce an induction winding which contains current-carrying means having low conduction losses, i.e. low resistance and low eddy current losses. Another aim is to produce a strong, flexible current-carrying means which form a compact induction winding. A further aim is to produce an induction winding which minimises the risk for partial discharges caused by the presence of cavities and pores in the insulation system around the current-carrying means. A yet further aim of the invention is to produce an induction winding for use at low (0-1 kV), medium- (1-34 kV) and high voltages (34 kV and higher) for small (mA) as well as high large currents (1A and higher). The induction winding according to the present invention is intended for used in induction devices with or without a core. The core comprises either magnetic or non-magnetic material. A further aim is to eliminate the need for a cooling system in an induction device.

These objects of the invention are achieved by utilising an induction winding according to the features given in the characterizing part of claim 1 and a method according to the features given in the characterizing part of claim 14. Advantageous embodiments are stated in the characterizing parts of the dependent claims.

In order to decrease conduction losses, decrease the size of an induction device and eliminate the need for a cooling system, the induction winding contains current-carrying means comprising nanostructures. The current-carrying means, which can be a single conductor or a power cable containing a plurality of conductors, comprise for example carbon nanofibres of the type described in WO 9839250 or individual nanostructures dispersed in a matrix. The term nanostructures includes all structures having a diameter in the range 0.1 to 100 nm. This includes structures such as open and closed, single- and multi-wall nanotubes, fullerenes, nanospheres, nanoribbons, nanoropes and nanofibres as well as nanotubes, nanoropes or nanofibres woven, plaited or twisted into a layer or a sheath. According to preferred embodiments of the invention the matrix is for example a polymer, ceramic, metal, non-metal, gel, fluid, an organic or inorganic material. The matrix can even comprise a thin layer of metal, gold for example, which wholly or partly covers the nanostructures providing metallic contact between adjacent nanostructures. A metal matrix decreases the contact resistance and improves the conduction between individual nanostructures, which leads to conductors having low conduction losses.

Nanostructure-containing current-carrying means can be made to be compact due to the nanostructures' small volume. More compact current-carrying means lead to a more compact induction winding. More induction winding turns in a given volume increases the inductance per unit volume. Current-carrying means containing nanostructures such as nanotubes oriented in a direction parallel to the conductor/s length represents an anisotropic electric conductor in which the resistance along it's length us low but the resistance in it's transversal direction is high. This means that a majority of the electrons will travel along the nanostructures and eddy current losses will be significantly reduced. In summary, using nanostructure-containing current-carrying means leads to a smaller, lighter and more efficient induction winding.

Each conductor constituting the current-carrying means is, for example, surrounded by an insulation system comprising insulation material located between two semiconducting layers. It is possible to form the entire current-carrying means from the same base material which would result in a flexible induction winding having a low density in which the risk for cavities and pores arising would be minimised.

Nanostructures such as carbon nanotubes are capable of conducting larger currents than conventional conductors. If the voltage across a nanostructure is decreased and the current is increased, thinner insulation can be used to attain the same active power output. If the thickness of the insulation remains the same, a higher current can be conducted through the conductor for a given voltage and therefore a higher active power output is attained.

### BRIEF DESCRIPTION OF THE DRAWING

A greater understanding of the invention may be obtained by reference to the accompanying drawing, when considered in conjunction with the subsequent description of the preferred embodiments, in which;

FIG. 1 shows a three dimensional view of an induction winding containing current-carrying means comprising individual nanostructures dispersed in a matrix according to a preferred embodiment of the invention

FIG. 2 shows a three dimensional view of an induction winding comprising two coaxial electric conductors containing nanostructures dispersed in a matrix according to a preferred embodiment of the invention

FIG. 3 depicts a 3-phase transformer with a laminated core comprising an induction winding according to a preferred embodiment of the invention, and

FIG. 4 illustrates a 2-pole electric DC motor as an example of an electric machine containing an induction winding according a preferred embodiment of the invention.

### DESCRIPTION OF PREFERRED EMBODIMENTS

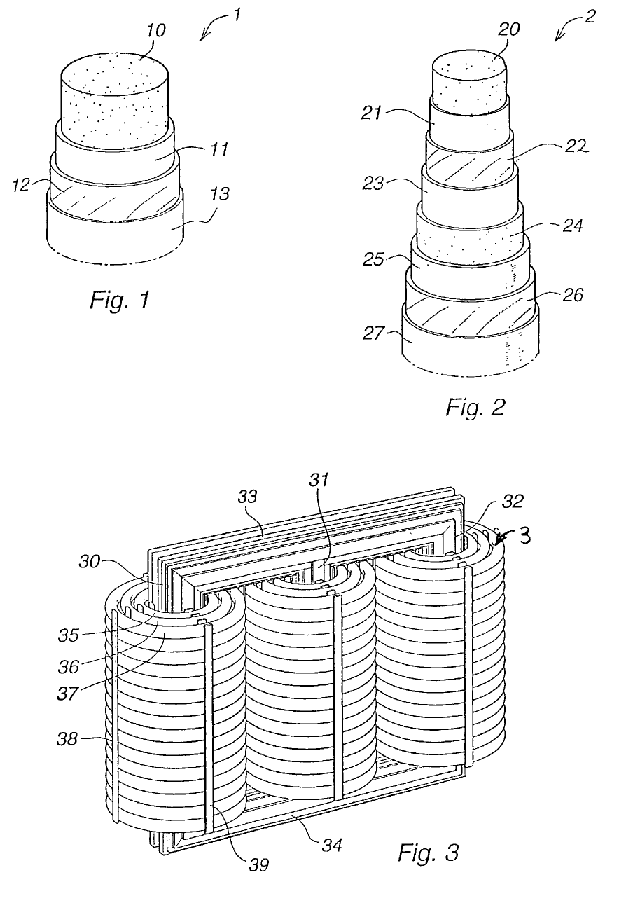

An induction winding 1 according to a preferred embodiment of the invention is shown in FIG. 1. It includes current-carrying means 10, which comprise individual nanostructures substantially homogeneously dispersed in a matrix, and an insulation system comprising an inner semiconducting layer 11, insulation material 12 and an outer semiconducting layer 13.

FIG. 2 shows an induction winding 2, which includes two coaxial electric conductors 20, 24, which comprise nanostructures substantially homogeneously dispersed in a matrix, and an insulation system. The innermost electric conductor's 20 insulation system includes an inner semiconducting layer 21, insulation material 22, and an outer semiconducting layer 23 and the outermost electric conductor's 24 insulation system includes an inner semiconducting layer 25, insulation material 26 and an outer semiconducting layer 27.

According to preferred embodiments of the invention the induction windings 1 and 2 include other components such as mechanical reinforcement. The electric conductors 10 and 20 have a circular geometry in the examples shown. Many other cross sections are possible and maybe even advantageous if for example a better packing density in a stator's slots is required. The induction winding contains at least one electric conductor comprising nanostructures such as individual nanotubes, nanoropes, or nanofibres dispersed in a matrix or continuous carbon nanofibres.

The semiconducting layers 11, 13, 21, 23, 25, 27 form equipotential surfaces and the electric field is relatively uniformly spread out over the insulation material. In this way the risk of breakdown of the insulation, material due to local concentrations in the electric field, with be eliminated. If the outer semiconducting layers 13, 27 are earthed, there will be no electric field outside said outer semiconducting layer. The outer semiconducting layer 13, 27 is maintained at a controlled potential, such as earth potential via substantially uniformly spaced contacts along the induction windings length, where the contact points are spaced close enough to eliminate the risk of partial discharges due to the voltage arising between contact points.

The insulation material 12, 22, 26 comprises, for example, a thermoplastic such as low/high-density polyethylene, low/high-density polypropylene, polybutylethylene, polymethylpentene, a fluoropolymer, such as Teflon™, polyvinylchloride, cross-linked material, such as cross-linked polyethylene, rubber material, such as ethylene propylene rubber or silicone rubber. The semiconducting layers are constituted of the same material as the insulation material but contain conducting material such as carbon black, metal or nanostructures such as carbon nanotubes with semiconducting/metallic properties. The individual layers of the insulation system are in contact with each other and in a preferred embodiment of the invention they are joined by the extrusion of radially adjacent layers. It is important to minimise the risk of forming cavities or pores in the insulation system, which can lead to partial discharges in the insulation material at high electric field strengths.

If one of the above mentioned (insulation) materials were used as matrix material, it would be possible to produce the whole induction winding from the same base material. Polyethylene can for example be used for the insulation, in the semiconducting layers by including some conducting material, such as carbon black, as well as matrix material. This eliminates the problem of attaining good adhesion between different materials, minimises problems due to the expansion of different materials in the presence of a temperature gradient and simplifies the induction winding production process. All of the layers within the induction winding, i.e. the insulation, the semiconducting layers, and outer covering are extruded together around the conductor/s. In order to produce a cable according to the present invention, the conductors, or even the whole induction winding are extruded in a simple extrusion process. The induction winding's components are extruded, or wound, in radially adjacent layers and then preferably, vulcanised to impart improved elasticity, strength and stability. The nanostructure-containing electric conductor is extruded through a nozzle to orient the nanostructures in a direction parallel to the conductor's length. The components of the insulation system can then be wound onto the conductor. Other production methods are possible and the processes are mentioned only as examples.

The induction winding of the present invention is intended for used in all induction devices. Two examples of induction devices, i.e. a transformer and a simple DC motor containing an induction winding according to the present invention are given below.

FIG. 3 illustrates a three-phase power transformer comprising an induction winding 3 according to the present invention and a laminated core. The core comprises three legs 30, 31, 32 and two yokes 33, 34. Induction windings according to the present invention are concentrically wound around the core's legs. Three such concentric induction windings 35, 36, 37 are shown. The inner induction winding 35 is a primary induction winding and the other two 36, 37 represent secondary induction windings. Spacers 38 and 39 are placed between the induction windings. The spacers can either comprise electrically insulating material and function to facilitate cooling and to mechanically support the induction windings or they can comprise electrically conducting material and function as part of the grounding system for the induction windings.

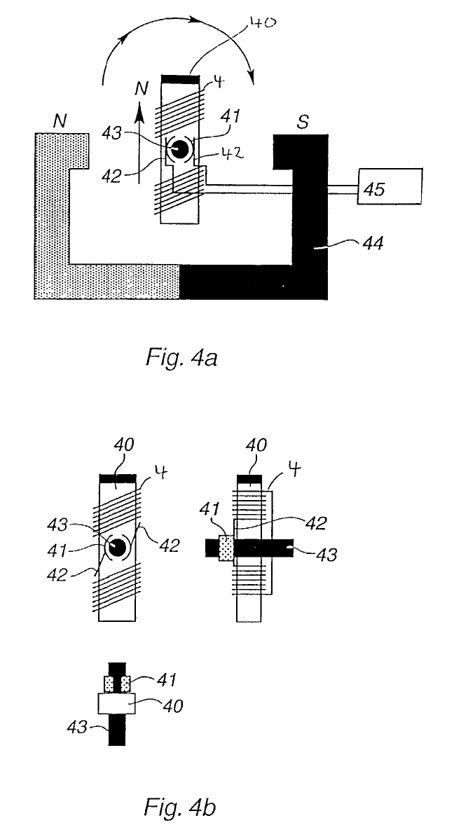

FIG. 4a illustrates an electric machine comprising an induction winding according to the present invention. The figure shows a simple 2-pole electric DC motor comprising a rotor 40, an induction winding 4, a commutator 41 which is connected to an axle 43, brushes 42, a stator 44 and connections to a DC source 45, such as a battery. The stator 44 is shown as a permanent magnet although it can be an electromagnet. When a current flows through the induction winding 4 a magnetic field is generated. The rotor's north pole is repelled by the stator's north pole and attracted to the stators south pole. Once this half-turn of motion is completed, the direction of the current through the induction winding is changed which flips the rotors poles causing the rotor to rotate about it's axis.

FIG. 4b shows front, side and top views of the rotor 40. The commutator 41 comprises a pair of contacts attached to the axle 43 which make contact with the induction winding 4. The brushes 42 comprise two pieces of flexible metal or carbon that make contact with the contacts of the commutator 41 and which are connected to the DC source 45. The change in the direction of current flowing through the induction winding is accomplished by the commutator 41 and the brushes 42 as the rotor rotates.

In a rotating electric machine there is normally an induction winding in the rotor, in the stator or in both. The stator is often laminated so that eddy-currents are restricted to individual laminations. The stator's induction winding is located in the stator's slots and the stator is earthed.

A transformer is often required to connect a rotating electric machine having a conventional induction winding to a power grid, as the voltage of the power grid is usually higher than the voltage of the rotating electric machine. The use of a transformer increases costs and gives rise to losses. A transformer is not required if the rotary machine is designed for high voltage by incorporating an induction winding according to the present invention.

1. An induction winding 1, 2, 3, 4 that contains current-carrying means, characterized in that the current-carrying means comprise nanostructures.

2. An induction winding 1, 2, 3, 4 according to claim 1, characterized in that said nanostructures comprise at least one of the following nanostructures: single-wall, multi-wall metallic, semiconducting.

3. An induction winding 1, 2, 3, 4 according to claim 1, characterized in that the electric conductor contains continuous fibres comprising metallic single-wall carbon nanotubes.

4. An induction winding 1, 2, 3, 4 according to any of the previous claims, characterized in that the electric conductor comprises a matrix in which the nanostructures are arranged.

5. An induction winding 1, 2, 3, 4 according to claim 4, characterized in that the matrix comprises at least one of the following: a polymer, ceramic, metal, non-metal, fluid, gel, carbon-containing material such as graphite, amorphous carbon or fullerenes, an organic or inorganic material or a combination of said materials.

6. An induction winding 1, 2, 3, 4 according to claims 4 or 5, characterized in that individual nanostructures are substantially uniformly dispersed in the matrix.

7. An induction winding 1, 2, 3, 4 according to any of the previous claims, characterized in that said current-carrying means are surrounded by an insulation system including two semiconducting layers with insulation material in-between.

8. An induction winding 1, 2, 3, 4 according to any of the previous claims, characterized in that said current-carrying means comprise at least two coaxial conductors.

9. An induction winding 1, 2, 3, 4 according to claim 8, characterized in that each conductor within said current-carrying means is in electric contact with an adjacent semiconducting layer.

10. An induction winding 1, 2, 3, 4 according to any of the claims 7-9, characterized in that the outer semiconducting layer is adapted to be maintained at a controlled electric potential.

11. An induction winding 1, 2, 3, 4 according to any of the previous claims, characterized in that said semiconducting layers comprise the same base-material as the insulation material and contain conducting material.

12. An induction winding 1, 2, 3, 4 according to claims 11, characterized in that said conducting material is carbon black, nanostructures, or metal.

13 An induction winding 1, 2, 3, 4 according to any of the claims 7-12, characterized in that said insulation material comprises at least one of the following: a thermoplastic, a fluoro-polymer, mica, cross-linked or rubber material.

14. A method for production of an induction winding according to any of the previous claims, characterized in that the nanostructures are incorporated into current-carrying means and an insulation system is applied around said electric conductor.

15. A method according to claim 14, characterized in that all of the insulation system's components are manufactured from the same base material and are extruded together.

16. A method according to claims 14 or 15, characterized in that said induction winding is vulcanised.

17. A method according to claim 14, characterized in that said insulation system is wound onto said electric conductor.

18. A method according to claim 14, characterized in that said induction winding is produced by a combination of extrusion and winding.

19. An induction winding in an induction device, characterized in that said induction device comprises at least one turn of an induction winding comprising nanostructures.

20. An induction winding according to claim 19, characterized in that said induction device has a magnetic core.

21. An induction winding according to claim 19, characterized in that said induction device has a non-magnetic core.

22. The use of an induction winding according to any of claims 1-13 or a method according to any of claims 14-18 in a static electric machine.

23. The use of an induction winding according to any of claims 1-13 or a method according to any of claims 14-18 in a rotary electric machine.

24 The use of an induction winding according to any of claims 1-13 or a method according to any of claims 14-18 in electric energy generation, transmission, distribution, conversion or consumption.
